(19) United States
(12) Patent Application Publication
(10) Pub. No.: US 2025/0155165 A1
(43) Pub. Date: May 15, 2025

(54) SYSTEM AND METHOD FOR INCREASED HEAT RECOVERY FROM LOW-PERMEABILITY GEOTHERMAL FIELDS

(71) Applicant: GreenFire Energy Inc., Walnut Creek, CA (US)

(72) Inventors: Greg Szutiak, Walnut Creek, CA (US); Alan D. Eastman, Walnut Creek, CA (US); John R. Muir, St. George, UT (US); Joseph A. Scherer, Oakland, CA (US)

(73) Assignee: GreenFire Energy Inc., Walnut Creek, CA (US)

(21) Appl. No.: 18/943,246

(22) Filed: Nov. 11, 2024

Related U.S. Application Data
(60) Provisional application No. 63/597,566, filed on Nov. 9, 2023.

(51) Int. Cl. F24T 50/00; F24T 10/15

(52) U.S. Cl. CPC F24T 50/00; F24T 10/15

(57) ABSTRACT

Methods and systems are disclosed for constructing a system for extracting geothermal energy from the subsurface. The method may include obtaining a primary wellbore extending from the surface of the earth and penetrating the subsurface, drilling, using a drilling system, a side-track wellbore extending from an intersection depth in the primary wellbore below the surface. The method further includes stimulating a portion of the subsurface lying between the primary wellbore and the side-track wellbore, and inserting a closed-loop flow-path, configured to receive a working fluid, into the primary wellbore. The closed-loop flow-path includes an uphole heat exchanger, a downbore heat exchanger, disposed within the primary wellbore at a depth greater than the intersection depth, and a bidirectional fluid conduit configured to channel cool working fluid from the uphole heat exchanger to the downbore heat exchanger and hot fluid from the downbore heat exchanger to the uphole heat exchanger.

### FIELD OF DISCLOSURE

Embodiments of the current disclosure may generally relate to the recovery of greater quantities of heat from subsurface geological formations via the drilling and completion of wellbores.

### BACKGROUND

Geothermal systems extract heat from subterranean rock formations and recover it to the surface where it can be used for a multitude of uses, including electrical generation and residential, commercial, and industrial heating. Although temperature typically increases with depth in the subsurface, suitable subterranean rock formations are often at a higher temperature than is normal for their depth. Often, although not always, these rock formations may be volcanic plutons—solidified magma injected between the surrounding layers—and may have low or very low permeability, making it difficult for fluids to flow or percolate through the rocks.

### SUMMARY

This summary is provided only to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method for constructing a system for extracting geothermal energy from a subsurface region. The method may include obtaining a primary wellbore extending from the surface of the earth and penetrating the subsurface, drilling, using a drilling system, a side-track wellbore extending from an intersection depth in the primary wellbore below the surface of the earth, and stimulating a portion of the subsurface lying between the primary wellbore and the side-track wellbore. The method may further include inserting a closed-loop flow-path, configured to receive a working fluid, into the primary wellbore, where the closed-loop flow-path includes an uphole heat exchanger, a downbore heat exchanger, disposed within the primary wellbore at a depth greater than the intersection depth, and a bidirectional fluid conduit configured to channel cool working fluid from the uphole heat exchanger to the downbore heat exchanger and hot fluid from the downbore heat exchanger to the uphole heat exchanger.

In general, in one aspect, embodiments relate to a method of operating a system for extracting geothermal energy from a subsurface region. The method may include pumping, using a pump at an uphole end of a closed-loop flow-path, a cool working fluid in a first direction through a bidirectional fluid conduit, receiving the cool working fluid flowing in the first direction at a downbore heat exchanger, and forming, by heating with the downbore heat exchanger, a hot working fluid from the cool working fluid, where the downbore heat exchanger transfers heat from a thermal cell to the cool working fluid. The method may further include channeling the hot working fluid in a second direction through the bidirectional fluid conduit to an uphole heat exchanger, and forming, by cooling with the uphole heat exchanger, the cool working fluid by extracting heat from the hot working fluid.

In general, in one aspect, embodiments relate to a system for extracting geothermal energy from a subsurface region, including a primary wellbore extending from the surface of the earth and penetrating the subsurface, a side-track wellbore penetrating the subsurface and intersecting the primary wellbore at an intersection depth below the surface of the earth, and a stimulated portion of the subsurface providing an enhanced permeability connection between the primary wellbore and the side-track wellbore. The system may further include a closed-loop flow-path containing a working fluid inserted into the primary wellbore, where the closed-loop flow-path includes an uphole heat exchanger, a downbore heat exchanger, disposed within the primary wellbore at a depth greater than the intersection depth, and a bidirectional fluid conduit channeling cool working fluid from the uphole heat exchanger to the downbore heat exchanger and warm fluid from the downbore heat exchanger to the uphole heat exchanger.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts a closed-loop geothermal system in accordance with prior art.

FIG. 2 depicts a drilling system in accordance with one or more embodiments.

FIGS. 3A-3C depict a process of drilling a side-track wellbore in accordance with one or more embodiments.

FIGS. 4A-4B depict a hydraulic fracturing system in accordance with one or more embodiments.

FIG. 5A-5D depict examples of bidirectional fluid conduit designs in accordance with one or more embodiments.

FIGS. 6A and 6B shows a closed-loop geothermal system in accordance with one or more embodiments.

FIGS. 7A-7B depict a primary well and a plurality of side-track wells in accordance with one or more embodiments.

FIG. 8 depict a flowchart in accordance with one or more embodiments.

FIG. 9 depict a flowchart in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details or with modifications to them. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a heat exchanger” includes reference to one or more of such heat exchangers.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

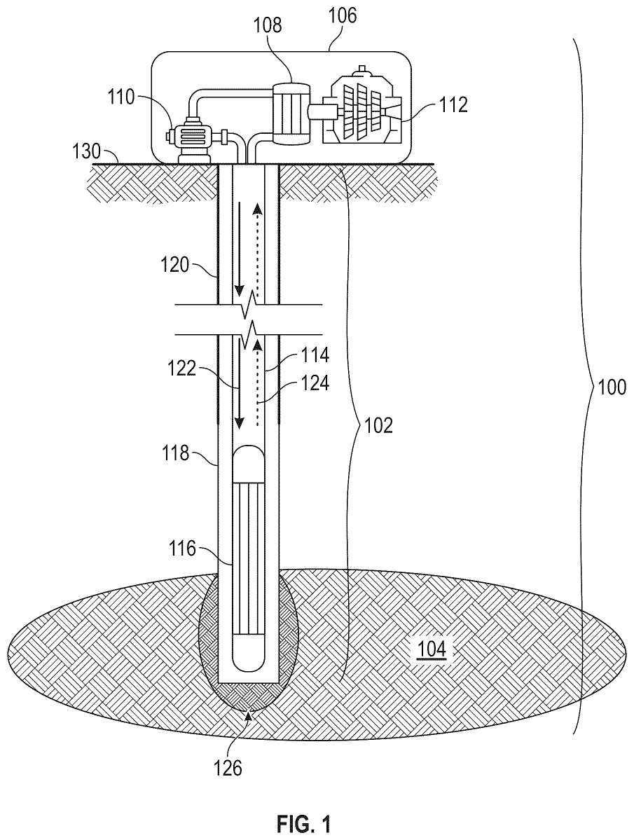

In the following description of FIGS. 1-8, any component described regarding a figure, in various embodiments disclosed herein, may be equivalent to one or more like-named components described regarding any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described regarding a corresponding like-named component in any other figure.

Hot-rock geothermal systems extract heat from hot underground rock formations, typically located at a depth of several thousand feet below the surface and transport it to facilities on the surface where it is used for a variety of beneficial purposes, such as, without limitation, the generation of electric power, the heating of residential, commercial, and industrial facilities, and in various industrial and/or chemical processes. Conventional geothermal systems (CGS) typically include two wellbores, an injection wellbore and an extraction wellbore drilled into a highly permeable and hot rock formation. A fluid, typically water or brine, is injected through the injection wellbore, percolates or flows through the permeable rock formation during which it is heated by the rock and is then extracted through the extraction wellbore. CGS are becoming less popular because it is increasingly difficult to find geothermal resources with the required abundance of fluid, usually brine, in sufficiently permeable rock. Sufficiently high permeability allows circulation system of hot brine to a production well that conveys the brine to the surface. Specialized surface equipment then extracts energy from the fluid, and the now-cooled brine is usually re-injected into the formation and the cycle is repeated.

So-called Enhanced Geothermal Systems (EGS systems) have been proposed as a solution to the permeability limitations of CGS. EGS systems are similar in concept to CGS, except that they are established in heated non-porous and lower permeability rock formations that may or may not contain suitable quantities of fluid. To create or enhance subsurface permeability, stimulation techniques are used by drillers to induce fractures in rock comprising the geothermal formation. Although these fractures may only millimeters wide, they must be a minimum of several hundred meters long to allow sufficient heat transfer from the rock into the fluid. The heated fluid can then be recovered and treated in a CGS system. EGS has not achieved commercial viability and success has been limited to a handful of sites. In addition, the persistent risk that large-scale stimulation may induce seismic activity has not been successfully mitigated. Moreover, achieving a successful stimulation campaign is difficult and expensive, and requires enormous quantities of water, which is scarce in many regions of the world, including the Western US, that have suitable hot subterranean rock formations.

As a result of these limitations of CGS, so-called “Advanced Geothermal Systems” (AGS) have been introduced. AGS are closed-loop systems that do not require any formation fluids to be extracted from the subsurface or need high subsurface permeability. In AGS a heat transfer fluid (“working fluid”) continuously circulates through one of more pipes that traverse a geothermally heated formation before returning to the surface. This property enables AGS systems to operate in a broad range of geological and geophysical settings, including hot dry rock areas where rock permeability is very low, or even zero. AGS systems substantially reduce project risk because they do not depend on either finding or creating subsurface permeability. The performance of closed-loop systems can be optimized by selecting or altering the chemistry of the heat-transfer fluid. AGS systems are easier to operate and maintain because there is very little danger of either contaminating the formation fluid or of the corrosive properties of many formation fluids proving detrimental to the piping system.

Typically, the heat is extracted at depth and transported to the surface using a working fluid, often water. In a closed-loop geothermal system, relatively cool working liquid is pumped down a first tubular (pipe) in a wellbore running from the surface to the source of geothermal heat. The cool working fluid is heated, using a downbore heat exchanger, such as a coaxial downbore heat exchanger (DBHX) and the resulting hot working fluid and/or gas, such as steam, is allowed to flow, or is pumped, up a second tubular to the surface where the heat is extracted, using a turbine linked to a generator or often with the aid of a heat exchanger on the surface. After the heat is extracted at the surface, the resulting cool working fluid then repeats the cycle.

Downbore, heat is provided to the working fluid by the surrounding hot rocks. However, unless the working fluid flow rate is carefully regulated, in the process of heating the cool working fluid received from the surface the surrounding rocks are cooled and the closed-loop geothermal system loses efficacy. Additional heat may flow into the rocks surrounding the wellbore from more distant regions of the subsurface to replace the heat supplied to the working fluid. However, this heat flow through the rocks may be slow in comparison to the rate needed to effectively operate the closed-loop geothermal system continuously. This may be particularly true when the geothermal heat source is composed of low permeability rocks through which formation fluid may percolate slowly, if at all. In such low permeability rocks the primary mechanism for heat flow may be conductive heat flow which for most rocks is typically very slow on human timescales or the life-span of the AGS.

In addition, for closed-loop systems deployed in hot dry rock formations, the heat exchanger and connecting conduits conveying working fluid to and from the heat exchanger may be insulated from the rock by poorly conducting gases, including air, that fill the annulus between the closed-loop system and the wellbore and act as a thermal insulator between the hot rock and the closed-loop system.

Disclosed herein are methods and systems for creating one or more side-track wellbores that may be drilled from a subsurface position in a primary wellbore in a direction that may be substantially parallel to the primary wellbore but offset at a distance that may be several tens to several hundreds of feet distant. Further, the methods and systems may provide for stimulating at least a portion of the rock formation lying between the primary and side-track wellbores in such a manner as to increase the permeability of the portion significantly above its previous, natural, in-situ, permeability. Such a stimulation may include, without limitation, hydraulic fracturing and/or acidizing.

Embodiments herein combine the use of a modified hydraulic fracturing technology and a geothermal fluid to increase the volume of hot source rock that an AGS may interact with, and from which heat may be harvested and the efficiency of the heat transfer process. Herein, the term “geothermal fluid” shall encompass both naturally occurring fluids present pores of the source rocks, residual drilling and stimulation fluids remaining after drilling completion and completion of the primary and sidetrack wellbores, and fluids introduced into the primary and/or sidetrack wellbores and the surrounding rocks for the purpose of facilitating heat transfer from the subsurface formation to the closed-loop system. The methods and systems may include creating and operating a thermal cell comprising circulating geothermal fluid along the side-track wellbore in an uphole direction, down the primary wellbore, from the point of intersection of the side-track and primary wellbore, in a downhole direction, and through the stimulated portion from the primary wellbore to the side-track wellbore. We note that the geothermal fluid may include, without limitation, the original pore fluid of the rock formation, i.e., the formation fluids contained in the formation of the rock, drilling mud, stimulation fluid, and or other fluid placed in the primary and/or side-track wellbore for the purpose of circulation, or any combination of the above. Herein, geothermal fluid is distinguished from the working fluid of the closed-loop geothermal system by the fact it is not permitted to flow uphole or downhole within the tubulars forming the closed-loop system, nor to mix directly or indirectly with the working fluid of the closed-loop geothermal system. Energy is extracted from the working fluid at the surface to create electric power or for direct use such as industrial processes.

The utility of embodiments of the closed-loop geothermal system with the thermal cell described herein lies in its ability to extract geothermal heat from a significantly greater volume of the geothermal source rock than can conventional systems and thus may operate with much greater efficacy and for longer periods than conventional systems before the accessible heat source becomes depleted.

One or more wellbores are disclosed herein. Some wellbores may run from the surface of the earth to depth within the subsurface. We will refer to these wellbores running from the surface as “primary” wellbores. Typically, primary wellbores may extend to a depth of many hundred to several thousand feet below the surface. Some or all of the primary wellbores may be vertical while portions may be highly deviated away from the vertical and/or horizontal. Other wellbores may branch off from a primary wellbore at a depth below the surface and may run parallel or sub-parallel to the primary wellbore at a distance of several tens to a few hundred feet from the primary wellbores. These branching wellbores are typically referred to as “side-track wellbores” or simply “side-tracks”. One or more side-tracks may be drilled from a single primary wellbore.

Locations within the primary wellbore at or near the intersection of the primary wellbore with the surface of the earth are referred to herein as “uphole” and locations within the primary wellbore at or near the termination of the primary wellbore in the subsurface as “downhole”. Similarly, for objects essentially oriented along the wellbore axis, the end of the object nearest the uphole end of the wellbore is referred to as the “uphole end” and the end of the wellbore nearest the downhole end of the wellbore as the “downhole end”.

FIG. 1 depicts the elements of a conventional closed-loop geothermal system (100) together with a method of operation. The system comprises a primary wellbore (102) running from the surface of the earth (130) to a geothermal heat source (104) in the subsurface. Typically, the heat source (104) will be one or more rock formations characterized by an elevated temperature that may lie at intervals to a depth of several thousand feet below the surface of the earth (130). Often the rock formation may be a volcanic pluton, solidified from molten lava injected by volcanic or tectonic forces between the surrounding rock formations, and have a low fluid permeability. The primary wellbore (102) may be substantially vertical, as shown, or may be significantly deviated. The primary wellbore (102) may also have horizontal portions, or even have portions that become shallower with increasing distance along the wellbore.

Portions of the primary wellbore may be cased, typically with steel pipe, to form a cased hole (120). Typically, at least the shallowest portions of the primary wellbore may be cased to provide mechanical stability to the wellbore and/or to isolate near-surface ground water, including drinking water aquifers from fluid originating at deeper depths and/or the drilling fluids used to create the primary wellbore (102). Often the casing will be cemented into place, using an annular sheath of cement between the exterior surface of the casing and the rock wall of the wellbore. In some cases, multiple sets (“strings”) of casing (not shown) may be present, disposed within one another and substantially sharing a common axis. Other portions of the primary wellbore (102) may be left uncased to create “openhole” portions (118) of the primary wellbore (102). While casing essentially isolates the interior of the cased hole (120) from the fluids in the surrounding rock formation and provides additional thermal insulation in the form of one or more layers of steel and cement, openhole portions (118) permit fluid, including hot fluid, and heat to flow more easily into and out of the openhole portion (118).

At, near, or above the surface of the earth (130) the primary wellbore (102) may connect to a heat utilization facility (106). The heat utilization facility (106) may include, without limitation, one or more heat exchangers, such as an uphole heat exchanger (108) to extract heat energy from the hot working fluid (124), and/or one or more turbines, such as turbine (112) to generate electrical power. The uphole turbine(s) may be connected to the uphole heat exchanger(s) or connected directly to the tubulars carrying the hot working fluid (124) uphole.

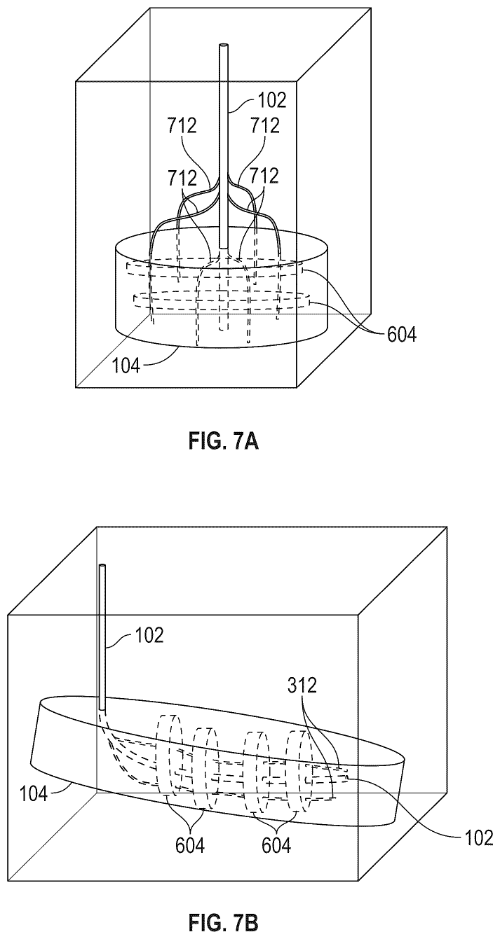

In accordance with one or more embodiments, a downbore heat exchanger (116) may be deployed within the primary wellbore (102). The downbore heat exchanger (116) may function to heat a cool working fluid (122) supplied to it by transferring heat from hot geothermal fluid surrounding the downbore heat exchanger (116) and producing hot working fluid (124). Tubulars (pipes) must fluidically connect the downbore heat exchanger (116) with the heat utilization facility (106) on the surface of the earth (130), and particularly with the uphole heat exchanger (108), allowing cool working fluid (122) to flow, or to be pumped, for example by uphole pump (110), downhole, and hot working fluid (124) to flow uphole. The tubulars must be configured to allow cool working fluid (122) to flow in one direction and hot working fluid (124) to flow in the opposite direction without mixing with one another. Examples of designs for such a bidirectional fluid conduit (114) are shown below in FIGS. 7A-7D.

Cool working fluid (122) may extract heat, for example using downbore heat exchanger (116), from the geothermal heat source (104), i.e., the hot rock formation. However, particularly in low permeability rocks the extraction of heat will cool the rock formation in a region surrounding the downbore heat exchanger (116), causing the temperature of this restricted zone (126) surrounding the downbore heat exchanger (116) to cool. Since many rocks are poor conductors of heat, and in low permeability rocks hot fluids cannot easily percolate into the restricted zone (126), the extracted heat cannot be easily replaced from more distant portions of the geothermal heat source (104) and the efficacy of the system may decrease over time. However, with careful regulation of flow, the system can reach a point of near equilibrium where the decline in power generation will be very slow over the lifecycle of the well.

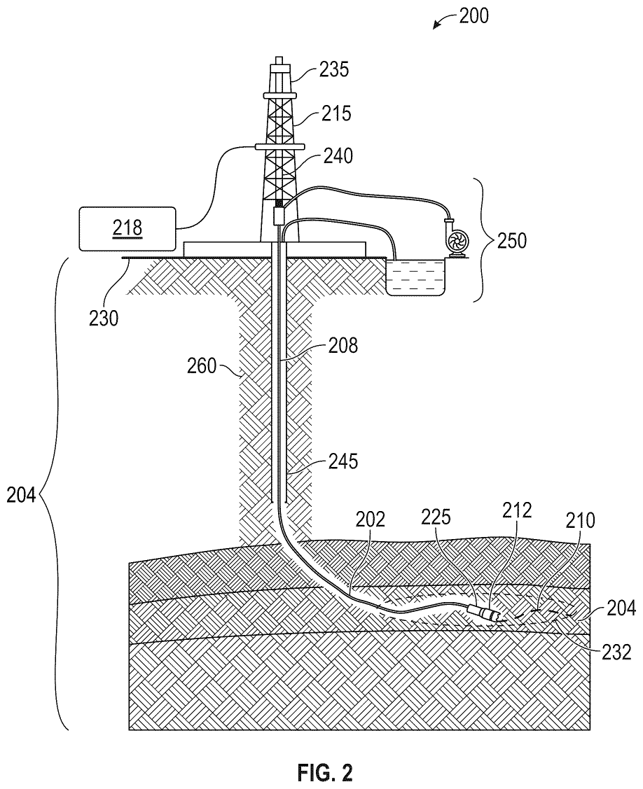

In some embodiments of the closed-loop geothermal systems disclosed herein, a pre-existing primary wellbore (102) may be used. For example, a wellbore previously drilled to provide fresh water, for geotechnical purposes, for open-loop geothermal purposes, or for hydrocarbon exploration may be used or extended for the closed-loop geothermal inventive system. In other embodiments, the primary wellbore (102) may be drilled specifically for the construction of the closed-loop geothermal invention using a wellbore drilling system, such as the wellbore drilling system depicted in FIG. 2.

FIG. 2 illustrates a drilling system (200) in accordance with one or more embodiments. In some embodiments, the drilling system (200) may be configured to drill a primary wellbore, such as primary wellbore (202) within the subterranean region of interest (204) guided by a wellbore drilling plan, that may include a planned wellbore path (210). In some embodiments, the wellbore drilling plan may be designed such that the wellbore path (210) penetrates the location of a geothermal heat source (206) within the subterranean region of interest (204). The planned wellbore path (210), and the resulting primary wellbore (202) may include substantially vertical portions, deviated and highly deviated portions, and horizontal portions, without departing form the scope of the invention.

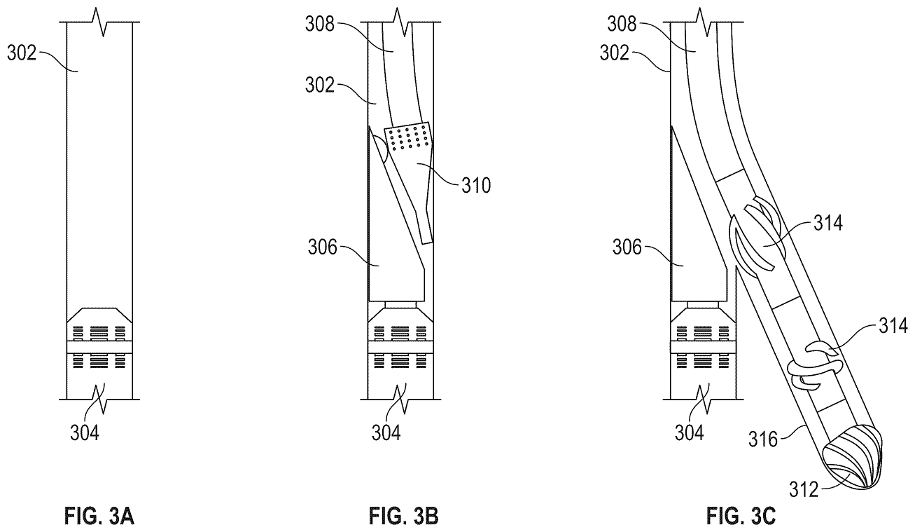

Although the drilling system (200) shown in FIG. 2 is depicted as drilling a primary wellbore (202) on land, the drilling system (200) may be a marine wellbore drilling system, including a jack-up rig, floating rig, semi-submersible rig, or drill-ship, without departing from the scope of the invention. Further, although the drilling system (200) shown in FIG. 2 is depicted as drilling a primary wellbore (202), the wellbore being drilled may be a sidetrack wellbore as described below and shown in FIG. 3. As such, the example of the drilling system the drilling system (200) shown in FIG. 2 is not meant to limit the disclosed and claimed invention.

As shown in FIG. 2, the drill rig may be equipped with a hoisting system, such as a derrick (215), which can raise or lower a drillstring (208) and other tools required to drill the primary wellbore (202). The drillstring (208) may include one or more drill pipes connected to form conduit and a bottom hole assembly (225) (BHA) disposed at the distal end of the drillstring (208). The BHA (225) may include a drill bit (230) to cut into rock (260). The BHA (225) may further include measurement tools, such as a measurement-while-drilling (MWD) tool and logging-while-drilling (LWD) tool. MWD tools may include sensors and hardware to measure downhole drilling parameters, such as the azimuth and inclination of the drill bit (212), the weight-on-bit, and the torque. The LWD measurements may include sensors, such as resistivity, gamma ray, and neutron density sensors, to characterize the rock (260) surrounding the primary wellbore (202). Both MWD and LWD measurements may be transmitted to the surface of the earth (230) using any suitable telemetry system known in the art, such as a mud-pulse or by wired-drill pipe.

To start drilling, or “spudding in,” the primary wellbore (202), the hoisting system lowers the drillstring (208) suspended from the derrick (215) of the drill rig towards the planned surface location of the primary wellbore (202). An engine, such as a diesel engine, may be used to supply power to a top drive (235) to rotate the drillstring (208) via a drive shaft (240). The weight of the drillstring (208) combined with the rotational motion enables the drill bit (212) to bore the primary wellbore (202).

The near-surface rock of the subterranean region of interest (204) is typically made up of loose or soft sediment or rock, so large diameter casing (245) (e.g., “base pipe” or “conductor casing”) is often put in place while drilling to stabilize and isolate the near-surface wellbore. At the top of the base pipe is the wellhead (not shown), which serves to provide pressure control through a series of spools, valves, or adapters. Once near-surface drilling has begun, water or drill fluid may be used to force the base pipe into place using a pumping system until the wellhead is situated just above the surface of the earth (230).

Drilling may continue without any casing (245) once deeper or more compact rock (260) is reached. While drilling, a drilling mud system (250) may pump drilling mud from a mud tank on the surface of the earth (230) through the drill pipe. Drilling mud serves various purposes, including pressure equalization, removal of rock cuttings, and drill bit cooling and lubrication.

At planned depth intervals, drilling may be paused and the drillstring (208) withdrawn from the primary wellbore (202). Sections of casing (245) may be connected, inserted, and cemented into the primary wellbore (202). Casing string may be cemented in place by pumping cement and mud, separated by a “cementing plug,” from the surface of the earth (230) through the drill pipe. The cementing plug and drilling mud force the cement through the drill pipe and into the annular space between the casing (245) and the wall of the primary wellbore (202). Once the cement cures, drilling may recommence. The drilling process is often performed in several stages. Therefore, the drilling and casing cycle may be repeated more than once, depending on the depth of the primary wellbore (202) and the pressure on the walls of the primary wellbore (202) from surrounding rock (260).

Due to the high pressures experienced by deep wellbores, a blowout preventer (BOP) may be installed at the wellhead to protect the rig and environment from unplanned oil or gas releases. As the primary wellbore (202) becomes deeper, both successively smaller drill bits (212) and casing (245) may be used. Drilling deviated or horizontal wellbores may require specialized drill bits (212) or drill assemblies.

The drilling system (200) may be disposed at and communicate with other systems in the wellbore environment, such as the wellbore planning system (218). The drilling system (200) may control at least a portion of a drilling operation by providing controls to various components of the drilling operation. In one or more embodiments, the drilling system (200) may receive data from one or more sensors arranged to measure controllable parameters of the drilling operation. As a non-limiting example, sensors may be arranged to measure weight-on-bit, drill rotational speed (RPM), flow rate of the mud pumps (GPM), and rate of penetration of the drilling operation (ROP). Each sensor may be positioned or configured to measure a desired physical stimulus. Drilling may be considered complete when a drilling target (232) within the geothermal heat source (210) is reached.

The direction of a wellbore may be controlled by both active and passive directional drilling (or steering). In passive directional drilling the well trajectory is determined by the flexing or buckling of the drilling (208) in response to the application of greater or lesser weight-on-bit and the design of the BHA (225). A conventional BHA equipped with multi-stabilizers may be used to control the hole deviation angle based on the lever principle or pendulum effect. However, the resulting wellbore path is also influenced by the natural features of strength or weakness of the rock formation and so the precision with which the wellbore trajectory can be controlled may be limited.

Active directional drilling may be performed using a variety of specialized BHA and drill bits known in the art. For example, BHA components known as “bent-subs” may hold the drill bit at a fixed orientation of a few degrees of deviation (typically, 1 or 2 degrees of angle) to the axis of the BHA. When the drillstring (208) is rotated the drill bit bores a portion of the wellbore in a direction parallel to the axis of the BHA. In contrast, when the drillstring (208) is unrotated but the drill bit rotated by a motor (e.g., a mud-motor or an electrical motor) then the wellbore is extended in the direction of orientation and the rate of deviation of the drillbit. Alternatively, wellbores may be deviated using rotatory steerable devices (RSD) that use continuously adjusted pressure pads on the BHA to push or point the drill bit, and hence the resulting wellbore, in the desired direction. Since RSDs work with the drillstring continuously rotating they are often preferred over bent-subs because of their superior drillstring drag-reduction and hole cleaning characteristics.

Although curves of 14 or 15 degrees per hundred feet of wellbore drilled are often achievable using direction drilling equipment and techniques known in the art, they are often insufficient to commence drilling a branched or side-track wellbore from an intermediate point in a pre-existing wellbore. The natural tendency of the BHA and drill bit to stay within the pre-existing wellbore rather than to bore a new side-track well is simply too much to overcome. For this reason, additional steps to “kick-off” a side-track wellbore from such an intermediate point are required. FIGS. 3A-3C illustrates some of these steps.

FIG. 3A illustrates an initial step of the side-track wellbore drilling process. To begin with, the wellbore (302), such as the primary wellbore (102), is blocked with a plug (304). In some embodiments, the blockage (304) may be a cement plug, while in other embodiments the blockage (304) may be a mechanical packer deployed using a wireline, coiled tubing or drillpipe conveyance. Typically, the blockage will not extend all the way to the bottom of the pre-existing wellbore (302) but will form a firm base upon which to place a “whipstock” (306) depicted in FIG. 3B. The whipstock (306), typically manufactured from a wear-resistant metal, may be oriented to deflect a drill bit and drillstring subsequently lowered onto it into a desired direction (for example, to the right in FIG. 3B). When the whipstock (306) is set in an openhole portion of the wellbore (302) then a drill bit lowered onto the whipstock (306) may be of a type suitable for drilling the full length of the desired side-track wellbore (316), shown in FIG. 3C. However, when the whipstock (306) is set in a cased hole portion of the wellbore (302) a specialized drill bit often referred to as a “mill” or a “mill bit”, and depicted by mill bit (310), may be used to mill or cut through the casing. Once the cut through the casing has been achieved, the drillstring (308) may be withdrawn from the wellbore (302), the mill bit (310) replaced with a drill bit and BHA suitable for drilling the remaining portion of the side-track wellbore (316), such as the drill bit (312) and BHA (314) depicted in FIG. 3C, and the drilling of the side-track wellbore (316) may proceed.

In accordance with one or more embodiments, it may be desirable to stimulate a portion of the geothermal heat source, i.e., the hot rock formation, located substantially between the primary wellbore (102) and one or more side-track wellbore (316). The purpose of stimulating the portion of the geothermal heat source is to increase the permeability of this portion above the previous, natural, or in-situ, permeability of the portion. For example, stimulation may include hydraulic fracturing and/or acidizing.

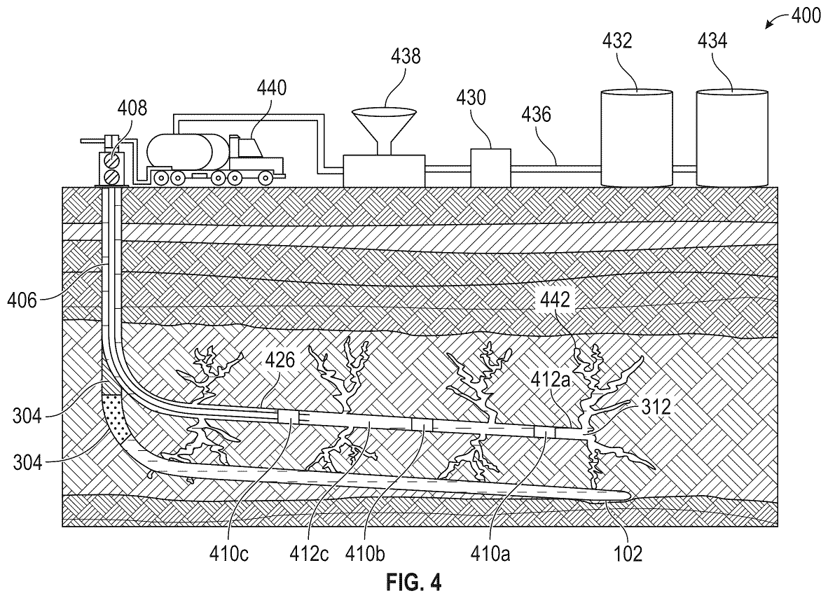

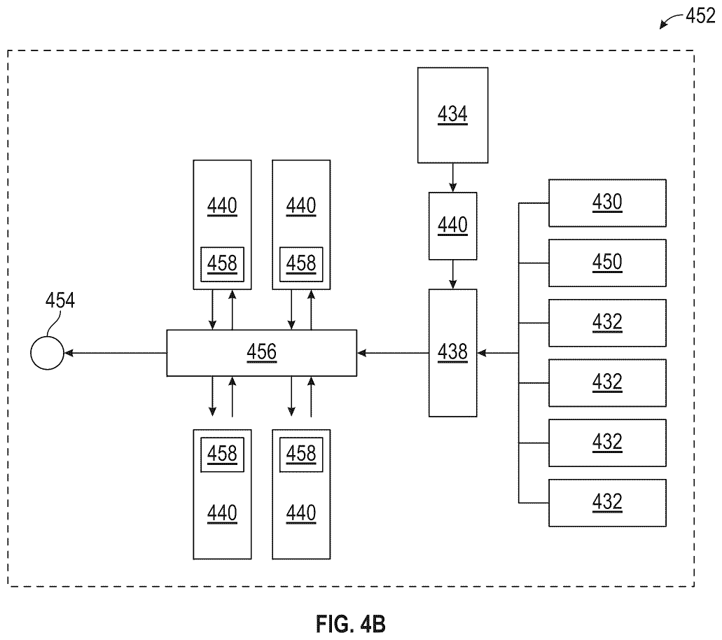

FIG. 4 illustrates a stimulation system, specifically a hydraulic fracturing system (400) performing a hydraulic fracturing operation in accordance with one or more embodiments. The hydraulic fracturing system (400) and hydraulic fracturing operation are for illustration purposes only. The scope of the disclosure is intended to encompass any type of hydraulic fracturing system (400) and hydraulic fracturing operation. However, the hydraulic fracturing system used in embodiments may often be a small scale, “slimmed-down”, or minimal system, as will be described below. This has the advantage of reducing unnecessary cost, time, and environmental impact.

Although the hydraulic fracturing system (400) may be deployed in either the primary wellbore (102) or the side-track wellbore (312), FIG. 4 and the corresponding description depicts the hydraulic fracturing system (400) as deployed in the side-track wellbore (312), however this should not be interpreted to limit the scope of the invention.

In some embodiments, the hydraulic fracturing operation is performed by separating the side-track wellbore (312) into multiple wellbore lengths separated by packers (410a-c) that hydraulically isolate the intervening lengths, sometimes termed “stages”, e.g., stages (412a-c). Each stage may be connected by tubing (406) to a set of valves attached to the wellhead at the surface, sometimes termed a “frac tree” (408). In some embodiments, a first packer (410a) may be installed near the toe of the sidetrack-well (312) to form a first stage (412a) that may be fractured. Then a second packer (410b) may be installed to form a second stage (412b) between the first packer (410a) and the second packer (410b) that may be fractured. Similarly, additional packers, e.g., packer (410c), may be installed sequentially one at a time to form additional stages, e.g., stage (412c) that may be fractured prior to the installation of the next pack in the sequential series. In other embodiments, a plurality of packers (410a-c) may be installed first with each stage connected to the tubing (406) from the frac tree (408) before isolating and fracturing each stage (412a-c) sequentially using valves (not shown) within the tubing (406). Typically, the tubing (406) and all the packers (410a-c) are removed from the well after the hydraulic fracturing is completed. In general, a single well 205 may have anywhere from one to more than forty stages, however for the embodiments described herein typically only a small number of stages are contemplated. For example, a lower stage (closest to the toe of the sidetrack), and intermediate stage (near the middle of the sidetrack), and an upper stage (near the intersection of the sidetrack with the primary wellbore). Often this small number of stages and stimulations will be adequate to provide the necessary permeability channels.

In an openhole portion of the wellbore hydraulic fracturing may of each stage may include a pumping operation where high-pressure fluid is pumped into the stage until the surrounding rock fractures. In cased-hole portions each stage may also include a perforation operation where holes are formed through the casing, often with the aid of explosive charges, such as focused explosive charges.

The frac tree (408) is similar to a production tree but is specifically installed for the hydraulic fracturing operation. The frac tree (408) tend to have larger bores and higher-pressure ratings than a production tree. Further, hydraulic fracturing operations frequently require abrasive materials being pumped into the well, such as side-track wellbore (312), at high pressures, so the frac tree (408) is designed and constructed from materials better able to handle a higher rate of erosion.

FIG. 4 further shows chemical storage containers (430), water storage containers (432), and proppant storage containers (434) that are constituents of the hydraulic fracturing system (400). In some embodiments disclosed herein, proppants and hence proppant storage containers (434) and not necessary and the proppant storage containers (434) may be omitted, however in other embodiments proppant may be used and the proppant storage containers (434) required. Frac lines (436) and transport belts (not pictured) transport the chemicals, proppant, and water from the storage containers (430), (432), (434) into a frac blender (438). Sensors (not pictured) may be located throughout this equipment to send signals to a monitoring system. The monitoring system may be used to control the volume of water, chemicals, and proppant used in the pumping operation.

The frac blender (438) blends the water, chemicals, and proppant to become the frac fluid (428). The frac fluid may be channeled to one or more frac pumps, often pump trucks (440), to be pumped through the frac tree 408 into the well. Each pump truck (440) includes a pump designed to pump the frac fluid at a certain pressure. More than one pump truck (440) may be used at a time to increase the pressure by combining the output frac fluid of each pump truck in a “frac manifold” (see FIG. 4B) before being pumped through the tubular (406) into the side-track wellbore (312). The frac fluid is transported from the frac manifold to the frac tree (408) using frac lines (436).

Initially, fluid pressure propagates and creates the hydraulic fractures, e.g., hydraulic fracture (442), later proppant, such as sand, may be pumped into the hydraulic fractures where the proppant props open the fractures (442) once the fluid pressure is released. Different chemicals may be used to lower friction pressure, prevent corrosion, etc. The pumping operation may be designed to last a certain length of time to ensure the fractures (442) have sufficiently propagated. Further, the frac fluid may have different make ups throughout the pumping operation to optimize the pumping operation without departing from the scope of the disclosure herein.

In some embodiments, acidizing may be performed as well as or instead of hydraulic fracturing and propping of the hydraulic fractures, particularly when the rock formation surrounding the wellbores are alkali in nature, such as carbonate and dolomite rocks. In these circumstances an acidic fluid may be pumped into the naturally existing fractures, the pores of the rock (where some background permeability exists) or into the hydraulic fractures. The acidic fluid may dissolve or etch the surfaces of the pores, natural or hydraulic fractures, to increase the permeability of the portion of the rock formation lying between the side-track wellbore (312) and the primary wellbore (102).

When the hydraulic fracturing and/or acidizing operation is completed, the frac tree (408) must be removed from the wellbore to perform the final completion operations which may include drilling out the packers (410a-c), plugs (304) and/or whipstock (306) used to drill the side-track wellbore (312). Subsequently, production tubing (not shown) and/or a thermal cell circulation pump (not shown) may be installed in the side-track wellbore (312).

FIG. 4B shows a schematic representation of the stimulation equipment used to stimulate a wellbore, specifically hydraulically fracture a wellbore, in plan form. The equipment may be arranged on a well pad (452). The well ad (452) may be an area of hardened ground such as concrete, asphalt or gravel surrounding the wellhead (454) on land or a jack-up or semisubmersible rig in water.

Water, acids, and chemicals, including biocides and viscosity modifiers, used for the stimulation may be held in storage tanks, such as water storage tanks (432), acid storage tank (450), and chemical storage tank (430) on the well pad (452). The storage tanks are commonly constructed from plastic or steel containers depending on the chemical properties of their intended contents. Chemicals are commonly added to water to enhance viscosity so that proppant such as sand is suspended in the fluid, decrease viscosity to facilitate pumping, enhance chemical break-ups to release the sand from the slurry mixture and biocides to eliminate any bacteria from the water. Each of the storage tanks may be in fluid connection, using pipes, valves, gauges, and low-pressure pumps as required, with a blender (438). In addition, proppants, used to maintain the permeability of hydraulic fractures once created by propping the fracture open, such as sand of various grain sizes, may be stored in a sand hopper (434). Proppants may be conveyed to the blender (438) from the sand hopper (434) using a sand conveyor (440) that may include one or more augers.

The blender (438) may be used to mix the fluids, including, water, acid, and other chemical, and the proppant, into a homogeneous fluid commonly referred to as “slurry”. During the execution of a stimulation job the composition of the slurry may be changed as a function of time. For example, initially the slurry may be almost exclusively water while the downhole pressure in the wellbore is raised to the pressure at which the rock formation surrounding the wellbore cracks and while the hydraulic fractures grow in extent from the wellbore. Later, proppant may be added to the slurry, often together with viscosity modifiers, to encourage the proppant to remain in suspension, and the resulting slurry pumped into the newly created hydraulic fractures. Optionally, depending on the rock type, acids may be added and the proportion of proppant in the slurry decreased with the goal of further broadening the finest fracture, both natural and anthropogenic, to enhance permeability still further. Once the slurry mixture has been mixed, low-pressure, often centrifugal, pumps transfer the fluid through a common pipeline to the frac manifold (456).

The frac manifold (456) may contain two separate fluid circuits, one for low pressure fluids and one for high pressure fluids. The low pressure line of the frac manifold (456) transports slurry from the blender (438) to the suction side of the positive displacement (PD) pumps (458). Depending on the configuration of the frac manifold (456) different numbers of inlet and outlet ports can be present. FIG. 4B shows four PD pumps (458) each pump mounted on a frac-truck (440) that houses the PD pump (458) as well as power supply, typically a diesel engine, and provides mobility for the pump and power supply to and from each hydraulic fracturing job. The line leading from blender (438) to PD pumps is also known as the low pressure line. Pressure coming from the blender (438) rarely exceeds 10 bar, therefore ports on this side of the frac manifold (456) in most instances are simple butterfly valves. Although FIG. 4B shows four PD pumps (458), this should not be considered limiting, and a greater or lesser number may be used. In particular, only a single PD pump mounted on a single frac-truck may often be used to generate the limited extent fractures required to run from the primary wellbore to the one or more sidetrack wellbores.

The high pressure line of the frac manifold (456) connects fluid coming from the discharge side of the PD pumps (458) towards the wellhead (454). A hydraulic fracturing site may have as many as 20 independent PD pumps with each pump capable of creating pressures up to 1000 bar (15,000 psi), although only four PD pumps (458) are depicted in FIG. 4B. The PD pumps (458) may have variable speeds that allow them to produce different flow rates. Individual PD pumps (458) may provide Mega Watts of power and are well-suited to provide both high flow rates and pressure for sustained periods. However, in many embodiments, because of the relatively short fractures required to reach from the primary wellbore to the one or more sidetracks pumping speeds producing low flow rates for a limited duration may be advantageous form a cost, deployment time, and environmental impact perspective.

After the drilling of the side-track wellbore (312) and the stimulation of the portion of the rock formation between the primary wellbore (102) and side-track wellbore (312) a downbore heat exchanger (116) must be attached to bidirectional fluid conduits (114) and inserted into the primary wellbore (102). The bidirectional fluid conduits (114) are characterized by their ability to form a first conduit or channel for a first fluid to flow in one direction through the bidirectional fluid conduit (114) and a second conduit or channel for a second fluid to flow in the reverse direction through the bidirectional fluid conduit (114) without the first and second fluid mixing with one another. These conduits are insulated from each other to prevent the cool fluid flowing down from absorbing heat from the hot fluid flowing upward.

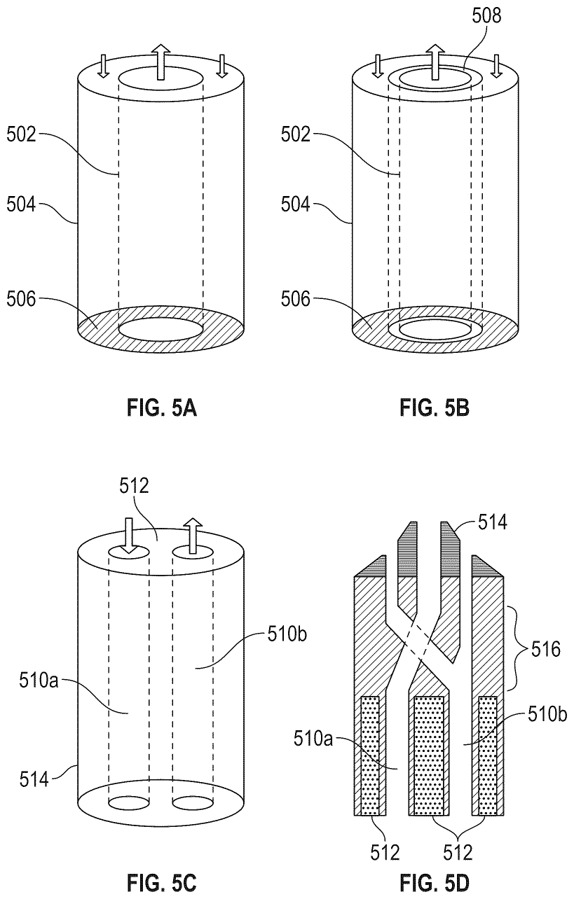

FIGS. 5A-5D depict examples of bidirectional fluid conduit designs in accordance with one or more embodiments. FIG. 5A shows a first design for a bidirectional fluid conduit (114). In FIG. 5A the bidirectional fluid conduit design includes two co-axial pipes with a first pipe (502) disposed within a second pipe (504). In some embodiments, the total cross-sectional area of the second pipe (504) may be essentially double the cross-sectional area of the first pipe (502), so that the cross-sectional area through which fluid can flow in one direction within the first pipe (502) is equal to the cross-sectional area of the annulus (506) through which fluid may flow in the reverse direction. For example, cool working fluid may flow in a first direction (downhole) in the central pipe (502) while hot working fluid may flow in the reverse direction (uphole) through the annulus, or vice versa.

It is beneficial to thermally isolate the two fluids from one another as much as is practical. Accordingly, as shown in FIG. 5B a thermally insulating layer or annulus (508) may be disposed between the first pipe (502) and the annulus (506). Alternatively, thermal insulation may be created by construction of the first pipe from a material exhibiting low thermal conductivity.

In other embodiments, the bidirectional fluid conduit (114) may include two pipes (510a) and (510b) of substantially equal cross-sectional areas running substantially parallel to each other side-by-side and embedded within a thermally insulating material (512) that in turn fills an exterior tubular (514), as shown in FIG. 5C. Typically, bidirectional fluid conduits (114) are manufactured in segments that may be 30-50 ft in length and multiple such segments are screwed together as they are deployed in the wellbore until they reach the desired length that may be several thousand feet in total. To allow the segments to be screwed together they may include a “male” screw thread (514), as shown in FIG. 5D, at one end and a corresponding “female” socket at the opposing end (not shown). Each segment may also include a cross-over section (516) at each end that transforms a side-by-side design to an annular form to facilitate the connect of the first pipe (510a) in a first segment to the first pipe in a second adjacent segment, and the second pipe (510b) in the first segment to the second pipe in the second adjacent segment.

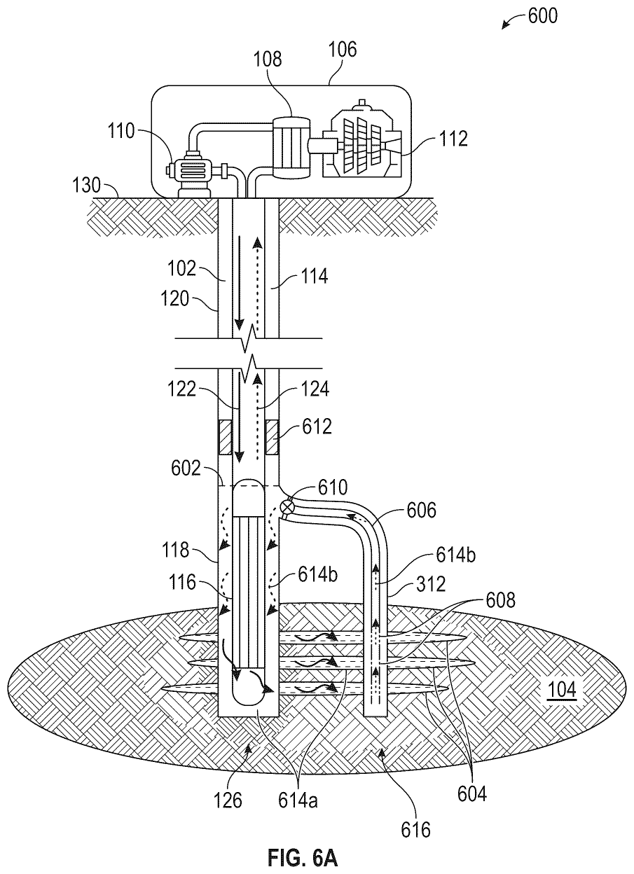

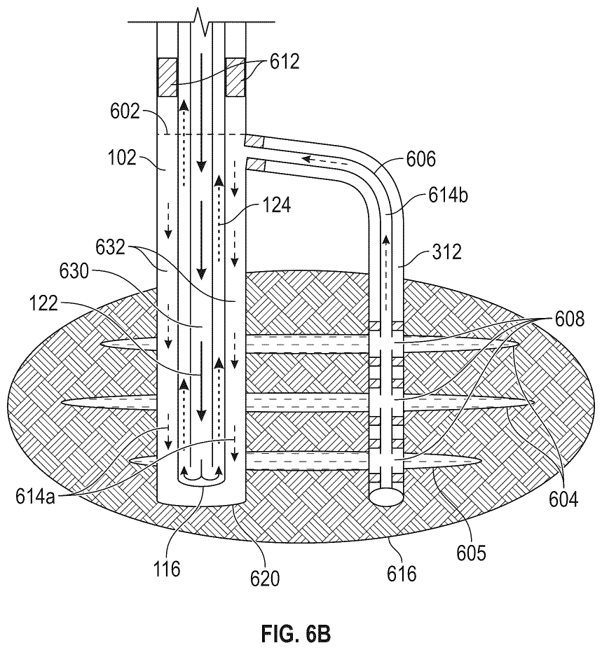

FIG. 6A depicts a closed-loop geothermal system (600) in accordance with one or more embodiments. Such a closed-loop geothermal system may be constructed with the drilling system, completion system and tubulars described in FIGS. 2, 3A-3C, 4A-4B, and 5A-5D. The closed-loop geothermal system (600) depicted in FIG. 6 shares many components with the closed-loop geothermal system depicted in FIG. 1 and, in the interest of brevity, shared elements are like numbered in FIG. 6 and FIG. 1 and will not be re-described in detail. Instead, attention will be focused on the new novel elements of the closed-loop geothermal system (600) shown in FIG. 6.

In particular, FIG. 6A depicts a side-track wellbore (312) running from an intersection point (602) with a primary wellbore (102) at an intersection depth below the surface in a direction that may be essentially parallel to the primary wellbore (102). In some embodiments, the primary wellbore (102) may be drilled for the purposes of creating the closed-loop geothermal system. However, in other embodiments the primary wellbore may have been created for another purpose, such as, without limitation, a water well, a geotechnical well, an open-loop geothermal system, or a hydrocarbon well; and subsequently repurposed to become the primary wellbore (102) of the closed-loop geothermal system. In accordance with some embodiments a packer (612) may be deployed on or around the bidirectional fluid conduit (114) in the primary wellbore (102), at a depth lesser than the intersection depth, to fluidly isolate an upper portion of the primary wellbore (102) from a lower portion of the primary wellbore (102). In some embodiments, the packer (612) may be deployed in the cased-hole section (120) of the primary wellbore (102), as shown in FIG. 6, or in other embodiments, may be deployed in the openhole section (118) of the primary wellbore (102).

In some embodiments, a tubular (606) may be deployed in the side-track wellbore (102). At the uphole end of the tubular, the tubular may be attached to a pump (610) that may be configured to convey geothermal hot geothermal fluid up the tubular and inject it into the primary wellbore (102) at the intersection depth (602) below the packer (612). However, in other embodiments either or both of the pump (610) and the tubing (606) may be absent. When present, the tubing may terminate in a series of slotted-sleeves (608), i.e., portions of tubing having a series of hole cut through the tubing to allow the flow of geothermal fluid into the interior of the tubing (606) from the exterior of the tubing (606). The slotted sleeves (608) may be disposed, at least approximately, at the location at which stimulated, e.g., hydraulically fractured, zones (604) intersect the side-track wellbore (312).

In some embodiments the hydraulically fractured zones (604) may only extend as far as is necessary to intersect both the primary wellbore and at least one of the sidetrack wellbores. For example, the hydraulically fractured, zones (604) may be only one hundred to a few hundred feet long, in comparison to conventional hydraulic fractures that may be many hundred to over a thousand feet long. Similarly, while the hydraulic fractures may be propped open by proppant, in many embodiments, in contrast to conventional hydraulic fracturing, little or no proppant may be used. When in operation, cool geothermal fluid (614a) flows, after cooling by the downbore heat exchanger (116), down the primary wellbore (102) and into the stimulated zones (604) where the cool geothermal fluid will be heated by contact with the hot rocks of the geothermal source (104). Concurrently, hot geothermal fluid (614b) will flow from the stimulated zones (604) into the side-track wellbore (312) and, when present, through the slotted sleeves (608) and into the tubing (606). The hot geothermal fluid (614b), assisted by the pump (610), when present, will flow uphole along the side-track wellbore (312) to the intersection point (602) of the side-track wellbore (312) and then be drawn down the primary wellbore (102) to the downbore heat exchanger (116).

This loop of geothermal fluid, driven either by the pump (610) or by the density differences of hot and cold geothermal fluid may be termed a “geothermal cell”. To be clear, the geothermal fluid circulating through the geothermal cell is distinct and separate from the working fluid circulating with the closed-loop geothermal system. The geothermal fluid may include water, brine or other fluids either previously present in the rocks of the geothermal source or introduced for the purpose down via the primary wellbore (102) outside the bidirectional fluid conduit. Other than through the exchange of heat at the downbore heat exchanger (116) and/or the exchange of heat at other points along the primary wellbore (102) the geothermal fluid never interacts or mixes with the working fluid of the closed-loop geothermal system.

In some embodiments, the flow of the geothermal fluid within the geothermal cell may be self-sustaining driven by the density changes in the geothermal fluid cause by the different temperature of the geothermal fluid at different point within the geothermal cell. In other embodiments, the flow of the geothermal fluid may be sustained and/or assisted by a pump, such as pump (610) positioned at some point within the primary wellbore (102), the sidetrack wellbore (312) or at their intersection.

The purpose of utilizing a geothermal cell, as illustrated in FIG. 6, over a conventional closed-loop geothermal system, such as the conventional system shown in FIG. 1, is that the geothermal fluid draws heat from an extended volume (616) of the geothermal heat source (104). This extended volume (616) may be much larger than the volume (126) from which a conventional closed-loop geothermal system, such as the conventional closed-loop system shown in FG. 1, extracts heat. Consequently, embodiments disclosed herein may permit the operation of the novel closed-loop geothermal system (600) to operate at higher temperatures for longer periods than a conventional system.

FIG. 6B shows an embodiment of the closed-loop geothermal system and the heat exchanger (114) in greater detail. In particular, the heat exchanger (114) shown in FIG. 6B extends over the entire length of the portion of the primary wellbore (102) lying between the intersection point (602) with the side-track wellbore (312) and the stimulated zone (605) that lies closest to the bottom (620) of the primary wellbore (102). In some embodiments the heat exchanger (114) may extend all the way from the packer (612) positioned above the intersection point (602) and the bottom (620) of the primary wellbore (102). Utilizing the entire length of the portion of the primary wellbore (102) lying between the packer (612) above the intersection point (602) and the bottom (620) of the primary wellbore (102) may maximize the efficacy of the heat exchanger (114).

FIG. 6B further schematically depicts a co-axial design of the heat exchanger (114) including and inner channel (630) arranged co-axially inside an outer channel (632). In some embodiments, a cool working fluid may be pumped down the inner channel (630) and flow back upwards within the annulus formed between the outer channel (632) and the inner channel (630). Heat from the hot geothermal fluid (614b) may be transmitted via thermal conduction through the walls of the external channel (632) and carried back to the surface of the earth.

The side-track wellbore (312) may be equipped with tubing (606) running from the intersection point (602) with the primary wellbore (602) to the positions of the stimulated zones (604). In some embodiments, slotted sleeves (608) may be attached to the stimulated zones (605) and (605), allowing hot geothermal fluid (614b) to enter the tubing (606) and flow under the force of thermal convention up to and into the primary wellbore (102). In some embodiments, the force of thermal convection may be supplemented by one or more pumps (not shown) installed of the tubing (606) or at the intersection point (602). In some embodiments, the stimulated zones may be isolated, collectively or individually, with hydraulically isolating packers position above and below each stimulated zone to prevent flow with the annulus formed by the walls of the side-track wellbore (312) and the walls of the tubing (606).

The stimulated zones (604), that may have been formed using hydraulic fracturing and/or acidizing, may differ from conventional stimulated zones used in hydrocarbon production in that the stimulated zones (604) need only span the gap between the primary wellbore (104) and the side-track wellbore (312). This distance may typically be only a few tens to a few hundred feet in length rather than the many hundred to a few thousand feet typical in hydrocarbon production.

FIG. 6B emphasizes that neither the cool working fluid (112) and the hot working fluid (124) mix nor intermingle with the geothermal fluid (614a) and (614b) circulating in the convective cell formed by the primary wellbore (102), the side-track wellbore (312) and the stimulated zones (604, 605). However, heat may flow through thermal conduction through the wall of the outer channel (63) of the heat exchanger from the hot geothermal fluid to raise the temperature of the working fluid (124) within the heat exchanger (124).

Although FIGS. 6A and 6B illustrate an embodiment with a vertical primary wellbore (102) and a single sidetrack (312), neither of these features is intended to limit the scope of the invention. For example, FIG. 7A depicts an embodiment with a single vertical primary wellbore (102) penetrating stimulated zones (604) within a heat source (104). However, from the primary wellbore (102) a plurality of side-track wellbores (712) may be drilled. In some embodiments, more than one side-track wellbore (712) may be drilled from effectively the same intersection depth, while in other embodiments a single side-track wellbore (712) may be drilled from each of a plurality of intersection depths. Further a plurality of side-track wellbores (712) may be drilled from each of a plurality of intersection depths.

Similarly, FIG. 7B shows a primary wellbore (102) drilled with a substantially vertical section and a substantially horizontal section. The substantially horizontal section is depicted penetrating a plurality of stimulated zones (604) lying within a heat source (104). In addition, two side-track wellbores (312) are drilled substantially parallel to the primary wellbore (102) and penetrating the geothermal heat source (104).

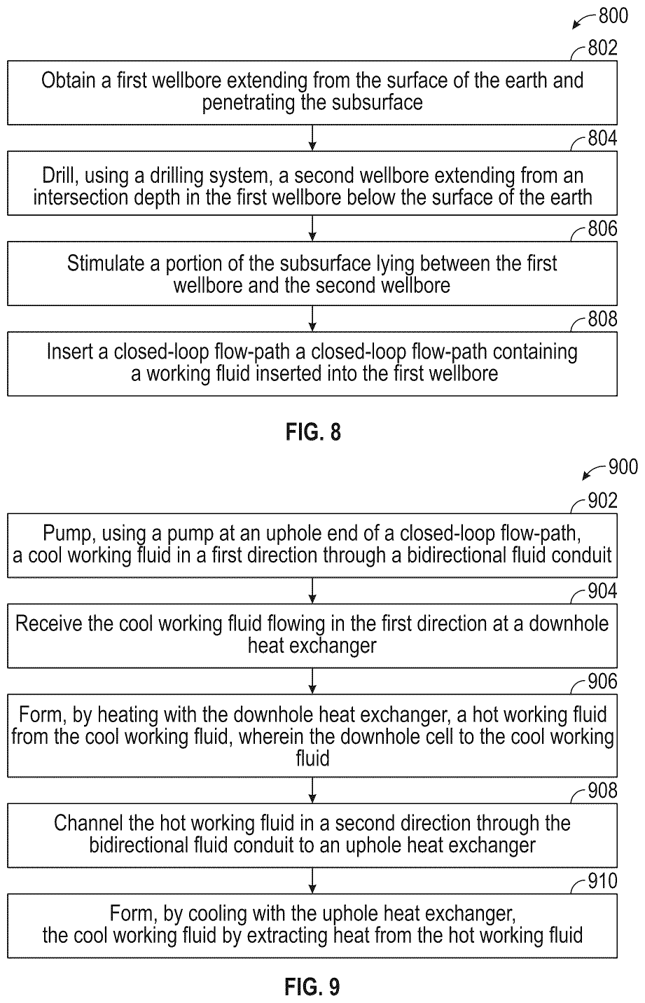

FIG. 8 shows a flowchart (800) in accordance with one or more embodiments. In step (802) a primary wellbore (102) extending from the surface of the earth (130) and penetrating the subsurface may be obtained. In some embodiments, the primary wellbore (102) may be drilled, using a drilling system (200) for the purpose of creating a closed-loop geothermal system, while in other embodiments the primary wellbore (102) may be a pre-existing wellbore drilled for another purpose, such as a geotechnical purpose, an open-loop geothermal system, a drinking water supply purpose, or a hydrocarbon exploration purpose.

In step (804) a side-track wellbore (312) extending from an intersection depth in the primary wellbore below the surface of the earth may be drilled, using a drilling system. In some embodiments, a plurality of side-track wellbores (312) may be drilled from one intersection depth, or a single side-track wellbore (312) may be drilled from each of a plurality of intersection depths.

In step (806) a portion of the subsurface lying between the primary wellbore and the side-track wellbore may be stimulated. Stimulating may include hydraulic fracturing using a hydraulic fracturing system (400) and/or acidizing the portion of the subsurface. The stimulation may be performed in any one of the side-track wellbore (312) or in the primary wellbore (102) or in both the primary wellbore (102) and the side-track wellbore(s) (312). In some embodiments, only enough hydraulic fracturing may be performed as to create only sufficient fracture to span the gap between the primary wellbore and at least one sidetrack and to intersect the primary wellbore and the sidetrack.

In step (808) a closed-loop flow-path, configured to receive a working fluid, is inserted into the primary wellbore. The closed-loop flow-path may include an uphole heat exchanger (108), a downbore heat exchanger (116) disposed within the primary wellbore at a depth greater than the intersection depth, and a bidirectional fluid conduit (114) configured to channel cool working fluid from the uphole heat exchanger to the downbore heat exchanger and hot fluid from the downbore heat exchanger to the uphole heat exchanger. In some embodiments, the closed-loop flow-path may further include a pump disposed at an uphole end of the closed-loop flow-path.

In some embodiments, a tubing string may be disposed in the side-track wellbore and in some embodiments a pump fluidically connected to side-track wellbore may be disposed at the intersection of the primary wellbore and the side-track wellbore. In some embodiments a packer may be disposed above the intersection depth of the primary wellbore and the side-track wellbore and configured to fluidically isolate an uphole portion of the primary wellbore from a downhole portion of the primary wellbore.

FIG. 9 shows a flowchart (900) in accordance with one or more embodiments. In step (902) a cool working fluid may be pumped, using a pump at an uphole end of a closed-loop flow-path, in a first direction, i.e., downward or downhole, in through a bidirectional fluid conduit. For example, the working fluid may be fresh water or fresh water mixed with chemical to inhibit corrosion and or biological activity within the closed-loop flow-path.

In step (904) the cool working fluid flowing in the first direction may be received at a downbore heat exchanger (116). The downbore heat exchanger (116) may be disposed at a first depth, at or near the bottom of the primary wellbore (102) and be configured to transfer heat from hot geothermal fluid to the cool working fluid.

In step (906) a hot working fluid may be formed from the cool working fluid, by heating with the downbore heat exchanger (116). Specifically, heat from the geothermal fluid will be absorbed, with the assistance of the downbore heat exchanger, into the cool working fluid until the working fluid becomes hot. The downbore heat exchanger (116) may be configured to transfer heat from the hot geothermal fluid of a thermal cell to the cool working fluid. The thermal cell may include the annulus of a primary wellbore surrounding the downbore heat exchanger (116) and/or the bidirectional fluid conduit, the downbore heat exchanger (116), a side-track wellbore that intersects the primary wellbore, and a stimulated portion of the subsurface region, configured to connect the annulus of the primary wellbore and the side-track wellbore. The stimulated portion may include a plurality of fluidically connected fractures. A geothermal fluid may fill the annulus of the primary wellbore, the side-track wellbore (312) and/or tubing disposed within the side-track wellbore (312), and the plurality of fluidically connected fractures within the stimulated portion.

In step (908) the hot working fluid may be channeled in a second direction, i.e., upward or uphole, through the bidirectional fluid conduit to an uphole heat exchanger (108) that may be located in a heat utilization facility (106) located on the surface of the earth (130). The uphole heat exchanger (108) may extract heat from the working fluid and use the heat for, without limitation, a multitude of purposes including generating electrical power, heating residential, commercial, and industrial building, as well as for a variety of industrial and manufacturing activities.

In step (910) cool working fluid may be formed, by cooling with the uphole heat exchanger (108), the hot working fluid received from the bidirectional fluid conduit. The cool working fluid may then be channeled back down the bidirectional fluid conduit, for example using the uphole pump (110), to repeat the circuit of the closed-loop geothermal system.

Embodiments disclosed herein may exhibit the following advantages. Disclosed is a method and system for extracting heat from a subsurface heat source, including a closed-loop geothermal system containing a working fluid in a primary wellbore, a secondary sidetrack wellbore drilled in the vicinity of the primary wellbore, and a small number of intermediate length fractures. A thermal cell may be established in which heated fluid flows into the sidetrack well, rises to the intersection of the sidetrack well and the primary well, and then sinks or is pumped down the primary well, past the heat exchanger of the closed loop system, and thence into the fractures and back to the sidetrack well. The system has the advantage of accessing a much larger, and hence longer lasting, source of hot rock than comparable closed-loop systems and yet requiring many fewer, and shorter hydraulic fractures than is commonly encountered. Consequently, creating these fractures require significantly less pumping equipment and consumables, e.g., proppant, and fracturing fluid, than is used for typical hydraulic fracturing applications, resulting in a corresponding reduction in cost and environmental impact on the surface compared to typical hydraulic fracturing operations.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method for constructing a system for extracting geothermal energy from a subsurface region, comprising:
obtaining a primary wellbore extending from a surface and penetrating the subsurface;
drilling, using a drilling system, a side-track wellbore extending from an intersection depth in the primary wellbore below the surface;
stimulating a portion of the subsurface lying between the primary wellbore and the side-track wellbore; and
inserting a closed-loop flow-path, configured to receive a working fluid, into the primary wellbore, wherein the closed-loop flow-path comprises:
an uphole heat exchanger,
a downbore heat exchanger, disposed within the primary wellbore at a depth greater than the intersection depth, and
a bidirectional fluid conduit configured to channel cool working fluid from the uphole heat exchanger to the downbore heat exchanger and hot fluid from the downbore heat exchanger to the uphole heat exchanger.

2. The method of claim 1, wherein the closed-loop flow-path further comprises a pump disposed at an uphole end of the closed-loop flow-path.

3. The method of claim 1, wherein stimulating comprises hydraulic fracturing using a hydraulic fracturing system.

4. The method of claim 1, further comprising disposing a tubing string in the side-track wellbore.

5. The method of claim 1, further comprising disposing a pump fluidically connected to side-track wellbore at the intersection of the primary wellbore and the side-track wellbore.

6. The method of claim 1, further comprising disposing a packer above the intersection depth of the primary wellbore and the side-track wellbore and configured to fluidically isolate an uphole portion of the primary wellbore from a downhole portion of the primary wellbore.

7. The method of claim 1, wherein obtaining the primary wellbore comprises drilling, using a drilling system, the primary wellbore.

8. The method of claim 1, wherein drilling the side-track wellbore comprises drilling a plurality of side-track wellbore.

9. A method of operating a system for extracting geothermal energy from a subsurface region, comprising:
pumping, using a pump at an uphole end of a closed-loop flow-path, a cool working fluid in a first direction through a bidirectional fluid conduit;
receiving the cool working fluid flowing in the first direction at a downbore heat exchanger;
forming, by heating with the downbore heat exchanger, a hot working fluid from the cool working fluid, wherein the downbore heat exchanger transfers heat from a thermal cell to the cool working fluid;
channeling the hot working fluid in a second direction through the bidirectional fluid conduit to an uphole heat exchanger; and
forming, by cooling with the uphole heat exchanger, the cool working fluid by extracting heat from the hot working fluid.

10. The method of claim 9, wherein the thermal cell comprises:
an annulus of a primary wellbore,
a downbore heat exchanger is disposed in the primary wellbore at a first depth;
a side-track wellbore, wherein the side-track wellbore intersects the primary wellbore at a location shallower than the first depth;
a stimulated portion of the subsurface region, configured to connect the annulus of the primary wellbore and the side-track wellbore, wherein the stimulated portion comprises a plurality of fluidically connected fractures; and
a geothermal fluid filling the annulus of the primary wellbore, the side-track wellbore, and the plurality of fluidically connected fractures within the stimulated portion.

11. The method of claim 10, wherein the stimulated portion comprises a hydraulically fractured portion.

12. A system for extracting geothermal energy from a subsurface region, comprising:
a primary wellbore extending from a surface and penetrating the subsurface;
a side-track wellbore penetrating the subsurface and intersecting the primary wellbore at an intersection depth below the surface;
a stimulated portion of the subsurface providing an enhanced permeability connection between the primary wellbore and the side-track wellbore; and
a closed-loop flow-path containing a working fluid inserted into the primary wellbore, wherein the closed-loop flow-path comprises:
an uphole heat exchanger,
a downbore heat exchanger, disposed within the primary wellbore at a depth greater than the intersection depth, and
a bidirectional fluid conduit channeling cool working fluid from the uphole heat exchanger to the downbore heat exchanger and warm fluid from the downbore heat exchanger to the uphole heat exchanger.

13. The system of claim 12, wherein the closed-loop flow-path further comprises a pump disposed at an uphole end of the closed-loop flow-path.

14. The system of claim 12, further comprising a tubing string disposed in the side-track wellbore.

15. The system of claim 14, wherein the tubing string comprises a slotted sleeve.

16. The system of claim 12, further comprising a pump disposed at the intersection of the primary wellbore and the side-track wellbore.

17. The system of claim 12, wherein the stimulated portion comprises a hydraulically fractured portion.

18. The system of claim 12, wherein a portion of the primary wellbore, the side-track wellbore, and the stimulated portion of the subsurface form a thermal cell.

19. The system of claim 12, wherein the side-track wellbore comprises a plurality of side-track wellbores.

20. The system of claim 12, wherein the bidirectional fluid conduit comprises a packer configured to fluidically isolate an uphole portion of the primary wellbore from a downhole portion of the primary wellbore.
